(19) United States
(12) Patent Application Publication
(10) Pub. No.: US 2006/0135365 A1
(43) Pub. Date: Jun. 22, 2006

(54) Wood chip capsule for fertilizer, agriculture pesticides and plant growth regulator, process and apparatus for producing the same

(76) Inventor: Sukyoung Chun, Gangwon-do (KR)

Correspondence Address: YOUNG & THOMPSON, 745 SOUTH 23RD STREET, 2ND FLOOR, ARLINGTON, VA, 22202, US

(21) Appl. No.: 10/529,388

(22) PCT Filed: Aug. 28, 2003
(86) PCT No.: PCT/KR03/01744

§ 371 Date: Mar. 28, 2005

(30) Foreign Application Priority Data
Sep. 27, 2002 (KR) 10-2002-0058834

(51) Int. Cl. A01N 59/04; A01N 25/00

(52) U.S. Cl. 504/101; 424/405

(57) ABSTRACT

The prevent invention relates to a wood chip capsule, process and apparatus for producing the same by producing a wood chip, drying the chip by air, and then infiltrating the chip containing any one of fertilizer, pesticide and plant growth regulator selected by a kind of crops into a crop by immersion method or pressurized method. The present invention makes it possible to provide new method for growing crops, which needs not to apply additional fertilizer during growing crops on subtoil by using the capsule as a fertilizer used at sowing time once a year.

### TECHNICAL FIELD

The present invention relates to a wood chip capsule for fertilizer, agriculture pesticides and plant growth regulator, process and apparatus for producing the same. In particular, it relates to a method and an apparatus for producing a wood chip capsule for fertilizer, agriculture pesticides and plant growth regulator by adding fertilizer, agriculture pesticides, plant growth regulator and others to wood chip and a wood chip capsule for fertilizer, agriculture pesticides and plant growth regulator manufactured using said apparatus.

### BACKGROUND ART

Growth of city and development of industry have polluted the soil and the river through various routes. There are various causes for the contamination of water and soil, but chemical fertilizer is not negligible. The chemical fertilizer contaminates catchments area, a fish farm, a reservoir and even soil. In the case of Korea, which has been reported as a water-shortage nation, especially there are severe eutrophication in catchments area and troubles in running water supply because of nitrogen and phosphate from agriculture.

The existing chemical fertilizers are diluted as soon as they spread and pollute water and soil, only 30˜40% of them acts as a fertilizer. Especially, there are severe eutrophication in catchments area of Korea and troubles in running water supply because of nitrogen and phosphate from agriculture. Furthermore, previous chemical fertilizers are applied more than 4 times a year and so washable that they tend to be overused to cause to barren soil.

The slow-release fertilizer was invented to correct the defects of said chemical fertilizer. The slow-release fertilizer supplies crops with nutrition neither more nor less during the entire growth-period of the crops. The slow-release fertilizer has the merits such as increase of utilization coefficient of fertilizer, continuous nutrition supply, minimum loss through sweeping, leaching, fixing, discomposing and vaporizing, prevention of Tip burn (Leaf burn) on the crops, reduction in labor-hour and cost and alleviation of water and soil pollution, but it has problem in high price.

Slow-releasing fertilizers developed so far can be roughly classified into two kinds, by a chemical way and a physical way. The chemical way denote to making fertilizers whose components have been turned to give difficultly soluble or difficultly decomposable properties, and the physical way denotes to making fertilizers which is coated with water-resisting substances to slow down dissolution-out velocity. The former has difficulty in controlling dissolution rate; the latter has deficiencies of complicated coating process, high price and leaving lots of water-resisting substances in soil. On this account, slow-release fertilizers have been uncommon yet.

Furthermore, the mass use of inorganic fertilizer erodes the soil, and at last makes it barren. The organic fertilizer plays an important role in reviving the barren soil by increasing humid in the soil. The organic fertilizer, generally made of organism remnants, is defined by fertilizing effect through microbial decomposition and crop's absorption. Besides the direct efficacy, the organic fertilizer maintains and promotes fertility of soil.

Taken a look into prior art of a slow-release fertilizer, the Ureaform, a slow-release nitrogen fertilizer compounded in U.S in 1946, has been merchandized from 1955. IBDU (Isobutylidene Diurea), CDU (Crotonylidene Diurea) and the like, which are chemical compounds similar to Ureaform, were invented to be used at highway sides, a golf course, fruits and vegetables etc. There are slow-release fertilizers by coating method like sulphur-coated urea and synthetic products of paraffin, asphalt and rosin with fertilizing components by matrix method, but these products have not been available for high price. In U.S by Allen etc, a slow-release fertilizer was manufactured with waste fiber by pressurized method permeating a fertilizer into pits of cell wall, however, it was non-economical for high cost in pressure treatment and could not be permeated in high-density.

In Korea, the Sulphur Coated Urine (SCU) was invented by National Institute of Agricultural Science and Technology in 1970's. After that, the Latex Coated Urine was invented and merchandized by CHO BI Co, Ltd. at 1985. As a slow-release fertilizer on sale in Korea, there are IBDU (Isobutylidene Diurea) complex fertilizer manufactured by mixing inorganic nitrogen, sulphur, potassium or a complex fertilizer with IBDU Nitrogen and CDU (Crotonylidene Diurea) complex fertilizer manufactured by mixing inorganic sulphur, potassium or a complex fertilizer with CDU (Crotonylidene Diurea) Nitrogen. As said above, the slow-release fertilizers disclosed so far in Korea have been made by coating nutrient particles with chemical material, but there has been no fertilizer capsulized into plant cell lumen. There were also wood capsules for fertilizer, however, they were simply manufactured by permeating solution using bark tissues of wood such as vessel and sieve tube and drying them.

The present inventors manufactured a slow-release fertilizer to solve the problems mentioned above by permeating chemical fertilizer into cell lumen which is obtained from small woods less than 14 cm in diameter, twigs, leaves and others. The present invention makes it possible to cut down permeating cost by utilizing water flow path of plant and is to capsulize high density of fertilizers using plant cells. Furthermore, the present invention, a wood capsule for fertilizer, agriculture pesticides and plant growth, not only carries out its role as a capsule for a fertilizer solution but also acts an organic fertilizer upon decomposition of plant cell.

The present invention is manufactured by the process of manufacturing a chip with wood, drying naturally, making it vacuous in a tank, permeating needed material according to kinds of crops into the chip through valve, pressing to 1˜40 kg/cm² at 15˜30° C. in normal pressure.

### DETAILED DESCRIPTION OF THE INVENTION

One objective of the present invention is to provide a method for manufacturing a wood chip capsule for fertilizer, agricultural pesticides and plant growth regulator. A further objective of the present invention is to provide a wood chip capsule for fertilizer, agricultural pesticides and plant growth regulator that are manufactured by the said method. A further objective of the present invention is to provide an apparatus for producing said wood chip capsule.

The objectives of the present invention were achieved by manufacturing wood chips, analyzing them quantitatively and affirming effectiveness of the wood chip capsule by measuring dissolving-out velocity according to kinds of woods, size of a wood chip and coating substances and fertilizing.

The method for manufacturing the wood chip capsule for fertilizer, agricultural pesticide and plant growth regulator presented in the present invention is comprised of the following steps:

(a) manufacturing a wood chip;

(b) drying naturally to 10˜40% water content; and

(c) permeating more than one selected from the group consisting of fertilizer, pesticides and plant growth regulator into said wood chip by pressurized method or immersion method.

It is possible to control dissolving-out velocity of fertilizer from said wood chip by changing size or kind of wood chip or coating it. It is preferable to be maintained at 15-30° C. and 1-40 kgf/cm² in said pressurized method. And when vacuum is maintained at the range 720 mmHg-760 mmHg, fertilizers, pesticides or plant growth regulator may be permeated sufficiently into wood chips.

Said fertilizers use substances containing nitrogen, phosphorous, potassium and others. As well as, general chemical pesticides or environment friendly pesticides extracted from plant may be used as said pesticides. As said coating substances, a mixture which comprises calcium, magnesium, iron, manganese, copper, zinc, silicon, magnesia, clay and lime or peanut hulls, yeast-containing waste material, fish waste material and others may be usable. Said wood capsules may be applied in two ways. First, it is to apply wood capsules, which are prepared by permeating a mixture of more than one selected from the group consisting of fertilizers, pesticides and plant growth regulators into it, in said step (c). Second, it is to apply wood capsules, which are prepared by permeating only one selected from the group of fertilizers, pesticides and plant growth regulators into it, by mixing them according to the uses in said step (c). Said uses mean that different kind or different mixture of wood capsules is preferable according to the kinds of crops or diseases and insects.

Said immersion method denotes a method consisting of forming wood into chips and immersing the chips in solution of fertilizers, pesticides and plant growth regulators. Said pressurized method denotes a method consisting of forming wood to chips and permeating fertilizers, pesticides and plant growth regulators into the chip under pressure.

An apparatus for manufacturing the wood chip capsule for fertilizers, pesticides and plant growth regulators presented in the present invention is shown in detail on FIG. 6.

The apparatus for manufacturing wood chip capsule 2 has an electric controller 10 which senses and controls on/off operation of a power switch supplying an electric current and sets up a vacuum pump operated by previously fixed information of the electric controller 12.

And the apparatus sets up a mixing tank 6, which becomes vacuum inside due to connection to a vacuum pipe 16 which has an aperture valve of vacuum operated by a signal of said electric controller 10. Said mixing tank is equipped with an aperture for chip 4 and a pressure gage 20 on the upper and has an exit valve 36 in exit pipe 34 connected to the lower outlet. Also, it is electrically connected to pressure gage, an indicating instrument and a recorder.

And said apparatus sets up a tank of solution 26 which is connected and set to a pipe of solution 22 equipped with a check valve 28 and an aperture valve of solution 24 operated by signal of the electric controller 10 to supply with definite amount of solution to said mixing tank 6, and a high pressure pump 14 which is connected and set with a high pressure pipe 30 equipped with a high pressure valve 32 diverged from said a pipe of solution 22 and operated by signal of the electric controller 10.

In explanation of operating said apparatus for manufacturing wood chip capsule 2 in example, a 30 mm-long, 25 mm-wide, 5 mm-thick wood chip dried naturally to 10-40% water content, is put into the mixing tank 6 through said aperture for chip 4.

After putting appropriate amount of wood chips into said mixing tank 6, the power switch 8 is placed on, the electric controller 10 senses it to operate vacuum pump 12 and high pressure pump 14.

In accordance with this, the electric controller 10 maintains an aperture valve for vacuum 18 of vacuum pipe 16 which connects vacuum pump 12 with mixing tank 6 open for fixed times to form a pressure of 760 mmHg inside mixing tank 6.

At this time, fine nets omitted in Figures that is inside the mixing tank 6 connected to the vacuum pipe 16 prevent wood chips from escaping out of mixing tank 6, which makes it easy to form vacuum in mixing tank 6.

Upon reaching the pressure inside said mixing tank 6 to 760 mmHg, pressure gauge 20 perceives that and an aperture valve of vacuum 18 of vacuum pipe 16 is shut and the operation of vacuum pump 12 stops.

When an aperture valve of solution 24 of pipe of solution 22 opens, solutions such as fertilizers, pesticides, plant growth regulator and coating substances from tank of solution 26 flow into the mixing tank 6 by vacuous pressure wherein the solutions are mixed with wood chips at normal pressure.

As the mixing tank 6 being maintained at normal pressure, an opening of high pressure valve 32 closing high pressure pipe 30 makes air pressure in operating high pressure pump 14 be supplied into the mixing tank 6 through high pressure pipe 30, check valve 28 and exit pipe 34.

If the pressure supplied into the mixing tank 6 was maintained at the range of 1 to 40 kgf/cm² for one or two hours, the amount of solution permeated into wood chips would be maximum, which is perceived by electric controller 10 to open exit valve 36 in exit tube 34 for regular interval, for wood chips to be discharged to exit tank 38.

The amount of wood chips discharged from the mixing tank 6 may be controllable diversely according to the size of chips.

Dissolving-out velocity of fertilizer in the present invention may be controlled in three ways. The bigger the size of chips is, the slower dissolving-out velocity is, so it is possible to control dissolving-rate by altering the size of them. But, the bigger the size of chip is, the longer the time for permeation is. Furthermore, the size of a pit in the plant cell wall is around 4 μm to 10 μm, different according to species of the plant, thus dissolving-out velocity can be controlled according to the species of the plant. Dissolving-out velocity is also controllable by blocking the pits in plant cell wall and cell lumen exposed using coating substances. Accordingly, dissolving-out velocity may be controlled according to the species of the plant and size of the chip or kind of fertilizer.

The fertilizing effect of the wood chip capsules prepared according to the present invention may be affirmed by applying the wood chip capsules for Oryza sativa and Chinese cabbage. As a result, the Oryza saliva applied with wood capsule shows superior tillering and fructification to the Oryza sativa applied with chemical fertilizer, and one application of the wood capsule shows higher yield than several time application of chemical fertilizer. It is believed that Nitrogen, phosphorous, potassium in the wood capsule is continuously supplied to crops for entire growth period. Therefore, the wood capsule is most available for a fertilizer, and that as a slow-releasing one not a quick-acting one. In the case of Chinese cabbage, same results are occurred in terms of dry weight and fructification. It is believed that Nitrogen, phosphorous, potassium in wood capsule is continuously supplied to crops for entire growth period. Accordingly, wood capsule for fertilizer is judged to accomplish a role as a slow-release fertilizer and can be applied for diverse crops. Wood capsule acts as organic fertilizer as well, though different in decomposition, and the remnants of nitrogen and phosphorous in wood capsule are also considerable.

### BRIEF DESCRIPTION OF THE FIGURES

FIG. 1 shows schematic representation of way to measure density of fertilizer after preparing a wood chip capsule according to the present invention.

FIG. 2 shows an apparatus for sampling to research growth and yield from treated group (wood capsule for fertilizer) and control group (chemical fertilizer).

FIG. 3 shows schematic diagram of nitrogen contents in wood capsule for fertilizer prepared according to the present invention.

FIG. 4 shows schematic diagram of phosphorous contents in wood capsule for fertilizer prepared according to the present invention.

FIG. 5 shows schematic diagram of potassium contents in wood capsule for fertilizer prepared according to the present invention.

FIG. 6 shows the process for manufacturing wood capsule for fertilizer.

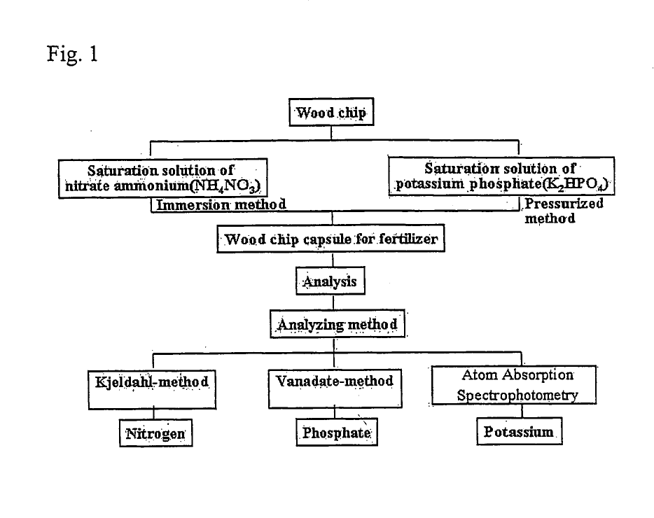

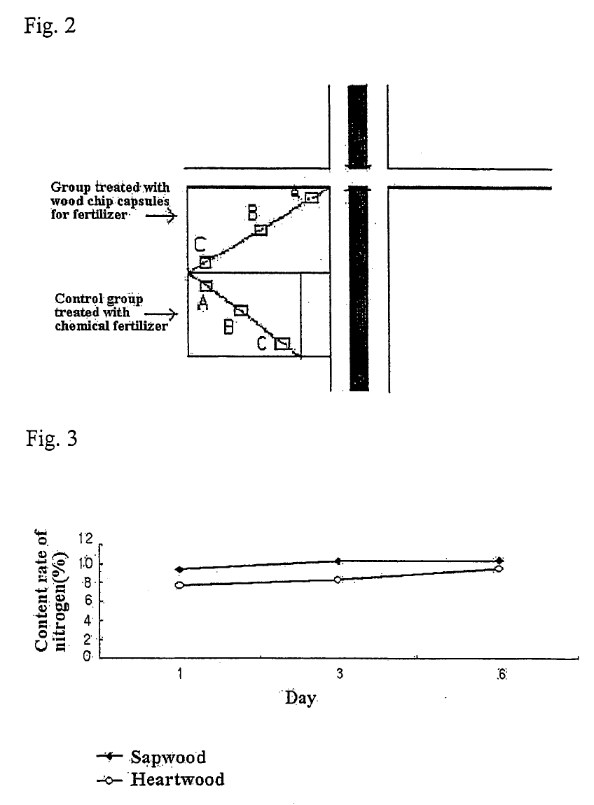

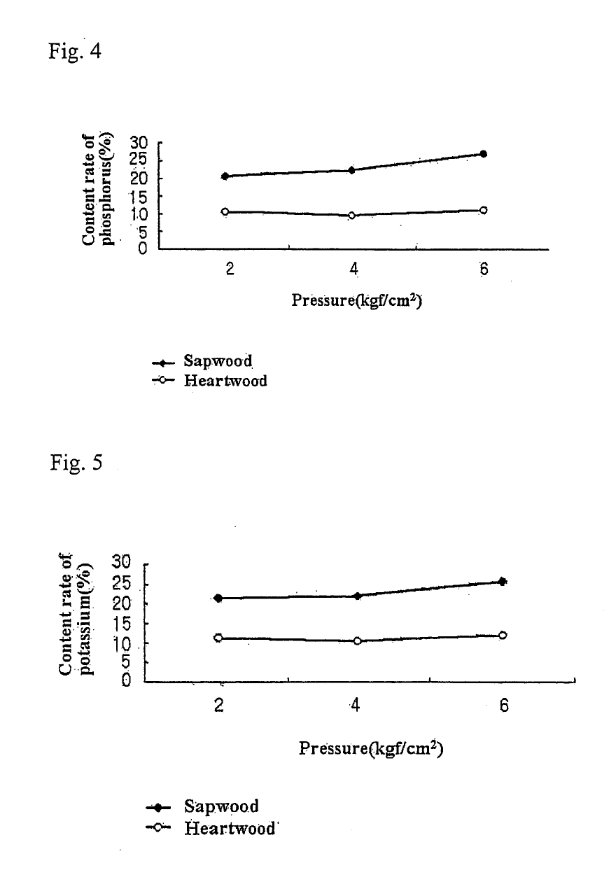

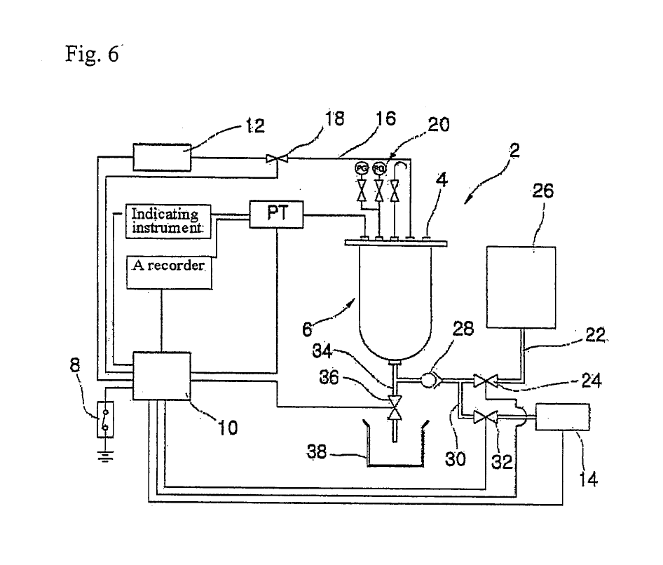

### *DESCRIPTION OF NUMERALS AND SYMBOLS IN THE FIGURES

2: apparatus for manufacturing wood capsules.
4: aperture for chips
6: mixing tank
8: power switch
10: electric controller
12: vacuum pump
14: high-pressure pump
16: vacuum pipe
18: aperture valve of vacuum
20: pressure gauge
22: pipe of solution
24: aperture valve of solution
26: tank of solution
28: check valve
30: high-pressure pipe
32: high-pressure valve
34: exit pipe
36: exit valve
38: exit tank

### DETAILED DISCRIPTION OF THE PREFERRED EMBODIMENT

### EXAMPLE 1

### Manufacture of a Wood Chip Capsule for Fertilizer in the Present Invention

### Experimental Example 1-1

### Selection of Fertilizing Solution for Manufacturing of a Wood Chip Capsule for Fertilizer

Pinus densiflora S. et Z. is used as a declared plant for the present invention. Potassium phosphate (K₂HPO₄) and nitrate ammonium (NH₄NO₃) were used as declared chemicals. A wood chip was formed 30 mm-long, 25 mm-wide and 5 mm-thick from said pine tree. Said wood chip was dried to reach constant at 105° C. for about 24 hours. With nitrogen reagents (NH₄Cl, NH₄NO₃, NH₄H₂PO₄, (NH₄)₂SO₄, NaNO₂), phosphate reagents (KH₂PO₄, K₂HPO₄, NH₄H₂PO₄, NaH₂PO₄. 2H₂O, K₃PO₄) and potassium reagents (KNO₃, KCl, K₂SO₄, KH₂PO₄, K₃PO₄), saturation solutions of 50 mL were made according to respective solubility of said reagents, and said wood chip had been soaking for one week. For quantitative analysis of total nitrogen permeated into said wood chip, analyze said wood chip in H₂O₂—H₂SO₄ method and quantify it in Kjeldahl-method. For quantitative analysis of total phosphorous and potassium, after 1 g of the wood capsule was put on dissolving condition three times for each 24 hours, analyze phosphorous quantitatively in Vanadate-method and analyze potassium in Atomic Absorption Spectrophotometry or with pH-meter (Table 1). As a result, ammonium nitrate (H₄NO₃) content is highest among nitrogen reagents and potassium phosphate (K₂HPO₄) is highest among phosphate reagents.

TABLE 1
Ingredients quantitative analysis of wood capsule made
of Pinus densiflora S. for fertilizer

| | Nitrogen | | Phosphorous | | Potassium | |
|---|---|---|---|---|---|---|
| Reagent | ppm | content(%) | ppm | content(%) | ppm | content(%) |
| NH₄Cl | 102,200 | 10.2 | | | | |
| NH₄NO₃ | 18,720 | 11.9 | | | | |
| NH₄H₂PO₄ | 68,600 | 6.9 | 152 | 1.5 | | |
| (NH₄)₂SO₄ | 107,240 | 10.7 | | | | |
| NaNO₂ | 55,720 | 5.6 | | | | |
| NaH₂PO₄.2H₂O | | | 183 | 1.8 | | |
| K₃P0₄ | | | 129 | 1.3 | | |
| KH₂PO₄ | | | 149 | 1.5 | | |
| K₂HPO₄ | | | 206 | 2.1 | | |
| KNO₃ | 51,520 | 5.2 | | | 652 | 6.5 |
| KCl | | | | | 862 | 8.6 |
| K₂SO₄ | | | | | 304 | 3.0 |

### Experimental Example 1-2

### Manufacture of a Wood Chip Capsule for Fertilizer in the Present Invention

To find out content of solution in nitrogen-wood capsule according to immersion time, wood chips (heartwood, sapwood) had been immersed into saturation solution of ammonium nitrate for one day, two days and six days intervals. To find out solution content in phosphorous and potassium-wood capsule according to air pressure, the wood chips (heartwood, sap wood) had been pressurized at the pressure 2 atm, 4 atm and 6 atm respectively for 45 minute under the condition of being poured saturation solution of potassium phosphate. The saturation solution was made with NH₄NO₃ (MV: 80.04 g/mol, Assay: 98%, Solubility: 214 g/100 mL, 25° C.) and K₂HPO₄(MV: 174.18 g/mol, Assay: 98%, Solubility 159 g/100 mL,

### Experimental Example 1-3

### Quantitative Analysis of the Wood Chip Capsule for Fertilizer

After breaking three of wood capsule (heartwood, sapwood) which were solution-treated in said experiment 1-1 to small pieces and drying them completely in a dryer at 105° C., 0.5 g of them was putted into 50 mL Erlenmeyer flask and analyzed in H₂O₂—H₂SO₄ wet digestion method. Quantitative analysis of wood capsule for nitrogen fertilizer was carried out in Kjeldahl method, quantitative analysis of wood capsule for phosphorous fertilizer was in Vanadate method and quantitative analysis of wood capsule for potassium fertilizer was in Atomic Absorption Spectrophotometry or pH-meter.

TABLE 2
Average components contents in the wood chip capsule
for fertilizer prepared by the pressurized method

| | SAP WOOD | | | HEARTWOOD | | |
|---|---|---|---|---|---|---|
| TEST | N(%) | P₂O₅(%) | K(%) | N(%) | P₂O₅(%) | K(%) |
| 1 | 9.30 | 20.60 | 21.10 | 7.66 | 10.50 | 11.10 |
| 2 | 10.26 | 22.26 | 21.93 | 8.20 | 9.53 | 10.43 |
| 3 | 10.30 | 27.10 | 25.80 | 9.43 | 11.16 | 11.93 |
| AVG | 9.95 | 23.32 | 22.94 | 8.43 | 10.39 | 11.15 |

[NOTE]
TEST 1: N is for one day, P₂O₅ is at 2 kgf/cm², K is at 2 kgf/cm²
TEST 2: N is for 3-days, P₂O₅ is at 4 kgf/cm², K is at 4 kgf/cm²
TEST 3: N is for 6-days, P₂O₅ is at 6 kgf/cm², K is at 6 kgf/cm²

Average content in sapwood capsules was N: P₂O₅: K=9.95%: 23.32%: 22.94%, and all fertilizing components was directly proportional to time and pressure as shown FIG. 3, 4 and FIG. 5. Especially, phosphorous and potassium components were more than two times of nitrogen component, it is believed that the reason for this is the pressure treatment of phosphorous and potassium components.

In heartwood chips, average content of components didn't showed difference as like N: P₂O₅: K=8.43%: 10.39%: 11.15% in the pressure treatment as well as the immersion treatment.

Comparing between sapwood and heartwood, nitrogen, phosphorous and potassium components generally showed higher contents and increase-rate in sapwood. In the case of immersion-treated nitrogen component, there was no difference according to sapwood and heartwood, but in the case of pressure-treated phosphorous component sapwood were two and half times higher than heartwood, in potassium were two times higher. Pressure below 1 kgf/cm² is ineffective, and pressure over 50 kgf/cm² is not appropriate for pressuring wood chips.

The reason for low content of fertilizing component in heartwood is considered the action of bordered pit-pair that acts mutually between cell lumen and tracheid. Actually at most of bordered pit-pair of conifer, pit-block by strong capillary power and pit-atresia by increase of extraction occurs during the process of becoming heartwood. Therefore, the reasons that fertilizing components may not permeate into heartwood are thought to be opening-rate of bordered pit and pit-block.

### EXAMPLE 2

### Dissolving-Out Velocity According to Species of Plants, Species of Fertilizers and Size of Wood Chips

To analyze a dissolving-out velocity according to species of plants, species of fertilizers and size of wood chips, special reagents and industrial reagents such as aqueous ammonia (NH₄OH), ammonium nitrate (NH₄NO₃), phosphoric acid (H₃PO₄) and phosphoric acid soda (NaH₂PO₄) were tested against Populus tomentiglandulosa, Alnus hirsuta and Pinus koraiensis

### Experimental Example 2-1

### Dissolving-Out Velocity of Nitrogen Solution According to Species of Plants, Class of Fertilizers and Size of Wood Chips

Wood chips were manufactured in regular hexahedron whose side was 4, 8, 12 mm long each. A test for dissolving-out of fertilizing components was accomplished through following steps. First step was to put 5 g of selected capsule fertilizers into each PVC vessels and then, put 25 mL of distilled water into the said vessels by automatic pipette. Second step was to filter said solvent after 24-hours to get sample 1 for analyzing. Third step was putting 25 mL of distilled water into again and after 24-hours filtering to get sample 2. Same process was repeated to get sample 3. The filtrates in sample 1, sample 2 and sample 3, were used for analyzing. As shown in the Table 2 as a result, when the size of wood chip was 12 mm³, dissolving-out was relatively slow. Taken a look into according to a class of fertilizers, aqueous ammonia (NH₄OH) was lower in permeation than ammonium nitrate (NH₄NO₃). Meanwhile, an amount of phosphorous permeated into the wood chip capsule was remarkably little compared to nitrogen. Especially, using of phosphoric acid (H₃PO₄) reagent made said tendency apparent.

TABLE 3
Nitrogen dissolving-out velocity of the wood chip capsules according
to species of wood, class of fertilizers and size of wood chips.

| | | Size | | | |
|---|---|---|---|---|---|
| | | of | Nitrogen(%) | | |
| | | wood | Sample | Sample | Sample |
| Species | fertilizers | chips | 1 | 2 | 3 |
| Populus | NH₄NO₃ | 12 mm³ | 8.340 | 2.200 | 0.216 |
| tomentiglandulosa | | 8 mm³ | 8.170 | 1.480 | 0.164 |
| | | 4 mm³ | 5.590 | 0.084 | 0.069 |
| | NH₄OH | 12 mm³ | 0.020 | 0.019 | 0.008 |
| | | 8 mm³ | 0.020 | 0.011 | 0.003 |
| | | 4 mm³ | 0.010 | 0.007 | 0.000 |
| Alnus hirsuta | NH₄NO₃ | 12 mm³ | 6.410 | 0.284 | 0.095 |
| | | 8 mm³ | 6.420 | 0.157 | 0.035 |
| | | 4 mm³ | 0.180 | 0.044 | 0.004 |
| | NH₄OH | 12 mm³ | 0.020 | 0.015 | 0.006 |
| | | 8 mm³ | 0.020 | 0.009 | 0.002 |
| | | 4 mm³ | 0.010 | 0.006 | 0.000 |
| Pinus koraiensis | NH₄NO₃ | 12 mm³ | 9.710 | 0.526 | 0.209 |
| | | 8 mm³ | 7.450 | 0.473 | 0.181 |
| | | 4 mm³ | 5.940 | 0.059 | 0.028 |
| | NH₄OH | 12 mm³ | 0.015 | 0.013 | 0.000 |
| | | 8 mm³ | 0.010 | 0.009 | 0.000 |
| | | 4 mm³ | 0.000 | 0.000 | 0.000 |

### Experimental Example 2-2

### Nitrogen, Phosphorous and Potassium Dissolving-Out Velocities According to Species of Wood and Class of Fertilizers

According to class of fertilizers, aqueous ammonia (NH₄OH) was lower in permeation than ammonium nitrate (NH₄NO₃) and an amount of phosphorous permeated into wood capsule was remarkably little compared to nitrogen (a tendency like this was apparent when H₃PO₄ is used), so dissolving-out velocity was tested again with ammonium nitrate (NH₄NO₃), phosphoric acid soda (NaH₂PO₄) and potassium chloride (KCl) as reagents. Due to slow dissolving in 12 mm³ big wood chip, the size of wood chip was fixed to 8 mm³ to compare dissolving-out velocity. As a result, the table 4 shows Nitrogen, Phosphorous and potassium dissolving-out velocities according to species of wood and class of fertilizers.

TABLE 4
Nitrogen, phosphorous and potassium dissolving-out velocity
according to species of wood and class of fertilizers.

| | Nitrogen (%) | | Phosphorous (%) | | Potassium (%) | |
|---|---|---|---|---|---|---|
| Species | Sample 1 | Sample 2 | Sample 1 | Sample 2 | Sample 1 | Sample 2 |
| Populus | 66.12 | 25.01 | 0.32 | 0.28 | 10.34 | 1.76 |
| tomentiglandulosa | 65.50 | 24.36 | 0.33 | 0.24 | 10.23 | 2.63 |
| | 79.10 | 26.89 | 0.29 | 0.28 | 10.27 | 1.49 |
| Pinus | 68.60 | 22.04 | 0.28 | 0.28 | | |
| koraiensis | 75.04 | 23.03 | 0.32 | 0.19 | | |
| | 81.92 | 25.96 | 0.39 | 0.28 | | |

The fact that nitrogen content was high in sample 1 filtrate and 22˜26% content in sample 2 filtrate verified possibility as a slow-release fertilizer of the wood chip capsule. Phosphorous was so little. Potassium showed high content over 10% in sample 1, but it was little in sample 2. It is thought that most of potassium dissolved out at the very beginning.

Considered the result mentioned above, it might be effective as a slow-release fertilizer when size of the present wood chip capsule is over 12 mm³.

### EXAMPLE 3

### Fertilizing Effect of the Present Wood Capsule for Fertilizing

The wood chip capsules prepared according to the present invention were spread for rice (Oryza sativa) and Chinese cabbage (Brassica campestris subsp. napus var. pekinensis) to evaluate fertilizing effect of them. The wood chip capsules for fertilizer were applied for Hwaseongbyeo Rice at 206, Keomyul-ri, Hongcheon-eup, Hongcheon-gun, Gangwon-do, Republic of Korea a Early Cultivar Rice at 893, Janghak-ri, Dong-myeon, Chuncheon-si, Gangwon-do, Republic of Korea and Oryza sativa at Gangwon Agricultural Research and Extension Services. At the same time, the wood chip capsules for fertilizer were applied for Chinese cabbage grown in spring in vinyl house and at highland. A method for applying wood chip capsules is spreading them on field before plowing, so they are buried under soil. All except but mentioned above was same as a grower does.

### Experimental Example 3-1

### Fertilizing Effect of the Wood Chip Capsule Prepared According to the Present Invention to Rice (Oryza sativa)

After the wood chip capsules being applied, the fertilizing effect was studied through a research of crop situation the year after applying.

To evaluate fertilizing effect to rice (Oryza sativa), the number of tillering, a feature of vegetative growth stage, was examined in wood chip capsule-applied rice and chemical fertilizer-applied rice. Table 5 and 6 represent the number of tillering in wood chip capsule-applied rice and chemical fertilizer-applied rice. Frequency of the examination was 7 times for Early Cultivar and 6 times for Oryza sativa at Gangwon Agricultural Research and Extension Services and an average was taken. In case of the Early Cultivar, the number of tillering in wood chip capsule-applied rice and chemical fertilizer-applied rice were each 35.3 and 35.1, which was little difference. But, the number of tillering of Oryza sativa at Gangwon Agricultural Research and Extension Services showed apparent difference. In the case of Quercus, Larch and Pine, The number of average tillering were 27.3, 26.3 and 25.3 respectively. On the other hand, chemical fertilizer-applied rice (Oryza sativa) showed 19.3 in the number of average tillering. Therefore, the tillering was excellent in wood chip capsule-applied rice than chemical fertilizer-applied one.

TABLE 5
The number of tillering of an Early Cultivar

| | The number of research (n) | | | | | | | |
|---|---|---|---|---|---|---|---|---|
| Fertilizer | 1 | 2 | 3 | 4 | 5 | 6 | 7 | Mean |
| Wood capsule | 35 | 31 | 45 | 32 | 29 | 32 | 43 | 35.3 |
| for fertilizer | | | | | | | | |
| (pine tree) | | | | | | | | |
| Chemical | 21 | 39 | 34 | 33 | 38 | 39 | 42 | 35.1 |
| Fertilizer | | | | | | | | |

TABLE 6
The number of tillering of Oryza sativa at Gangwon
Agricultural Research and Extension Services

The number of research

| Fertilizer | 1 | 2 | 3 | 4 | 5 | 6 | Avg |
|---|---|---|---|---|---|---|---|
| Quercus | 20 | 19 | 27 | 28 | 31 | 39 | 27.3 |
| Larch | 20 | 22 | 33 | 34 | 30 | 19 | 26.3 |
| Pine | 20 | 17 | 20 | 31 | 31 | 33 | 25.3 |
| Chemical | 14 | 16 | 23 | 20 | 20 | 26 | 19.3 |
| fertilizer | | | | | | | |

After the wood chip capsules for fertilizer and chemical fertilizer being applied for a Hwaseongbyeo Rice, a Early Cultivar and Oryza sativa at Gangwon Agricultural Research and Extension Services, a research of crop situation was carried out. Table 7 represents the fertilizing effect of wood chip capsule and chemical fertilizer applied for Hwaseongbyeo Rice. The factors are plating distance, lamina, leaf width, the number of culm, culm length, panicle length, the number of panicle, the number of grain and grain filling rate. Plating distance denotes the distance between rice and rice. Lamina denotes the length of the longest leaf in a head. Leaf width denotes the length of most wide part in the longest leaf in a head. The number of culm denotes total number of culm in a head. Culm length denotes the distance from the ground to a neck of spike. Panicle length denotes the distance from a neck of spike to the end of spike. The number of panicle denotes total number of spike in a head. The number of grain denotes total number of empty or filled grain. Grain filling rate denotes level of ripeness.

A method for the experiment was to collect said factors from three-divided zone to which treated group (wood capsules) and control group (chemical fertilizer) had been applied and average the collected numerical values. Resulting from the examination of crop situation, the grain number and grain-filling rate deciding fructification showed higher numerical values in wood chip capsule than chemical fertilizer. The grain number from them in the treated group was 120.20, and that of them in the control group was 107.20. Furthermore, the grain-filling rate of them in the treated group was 85%, and that of them in the control group was 76.50%. Concerned the number of panicle, wood chip capsule was not more effective than chemical fertilizer.

Table 8 represents a fertilizing effect to an Early Cultivar. The species of wood is pine. The number of panicle, the number of grain and grain filling rate decide fructification. As shown in table 5, the wood chip capsule for fertilizer was found out to excel chemical fertilizer in these three factors. The number of panicle, the number of grain and grain filling rate from the wood chip capsule for fertilizer were 18.3, 80.7 and 8.5%. But, The number of panicle, the number of grain and grain filling rate from the chemical fertilizer were 16.5, 80.7 and 80.0%. The weights of rough rice of a hundred heads from the wood chip capsule for fertilizer and the chemical fertilizer were 3,223 g and 2,643 g, numerical difference of about 600 g. Production per 10a (are) from the wood chip capsule for fertilizer outnumbered that from the chemical fertilizer by 89 kg in rough rice, 72 kg in brown rice and 66 kg in milled rice.

Table 9 represents a fertilizing effect to Oryza sativa at Gangwon Agricultural Research and Extension Services. The species of wood are Quercus, Larch and pine. As a result of the experiment, all species of wood chip capsule for fertilizer were more effective than the chemical fertilizer. Average panicle number, grain number and grain filling rate of three species of the wood chip capsules were 16.9, 86.1 and 82.3%. Average panicle number, grain number and grain filling rate of the chemical fertilizer were evaluated to 16.5, 80.7 and 80.0%. The weights of rough rice of a hundred heads from the wood chip capsule for fertilizer and the chemical fertilizer were 3,014 g and 2,643 g at average, numerical difference of about 371 g. Production per 10a (are) from three species of wood chip capsule for fertilizer outnumbered that from the chemical fertilizer by 151 kg in rough rice, 119 kg in brown rice and 110 kg in milled rice.

To synthesis of said results, the capsule fertilizer-applied rice (Oryza sativa) showed more excellent tillering number and fructification than the chemical fertilizer-applied rice (Oryza sativa). It was found out that production in the field where the capsule fertilizer prepared according to the present invention was applied once a year increased compared to several application of chemical fertilizer. It is estimated that nitrogen, phosphorous and potassium components should be supplied continuously to crops for entire growth period. Therefore, the wood chip capsule may be highly available for a fertilizer, as a slow-release fertilizer not a quick-acting fertilizer.

TABLE 7
Fertilizing effects of chemical fertilizer and wood chip capsule for
fertilizer applied for Hwaseongbyeo Rice

| | Chemical | Wood capsule |
|---|---|---|
| Class | fertilizer | for fertilizer |
| Plating distance (cm) | 22.10 | 19.60 |
| Lamina (cm) | 42.62 | 38.93 |
| Leaf width (cm) | 1.38 | 1.37 |
| The number of culm (n) | 26.19 | 23.20 |
| Culm length (cm) | 73.63 | 72.69 |
| Panicle length (cm) | 17.89 | 19.82 |
| The number of panicle (n) | 12.00 | 10.30 |
| The number of grain (n) | 107.20 (10.3) | 120.20 (10.1) |
| Grain filling rate (%) | 76.50 | 85.00 |

TABLE 8
Fertilizing effects of chemical fertilizer and wood
chip capsule for fertilizer applied for an Early Culvitar.

| | | | | | | | A | | | | |
|---|---|---|---|---|---|---|---|---|---|---|---|
| | | | | | | Weight | brown/ | Weight of | | | |
| | | | | | Grain | of | rough | rough rice | Yield per 10a | | |
| | Culm | Panicle | Panicle | Grain | filling | 1000 | rice | of 100 | (kg/10a) | | |
| | length | length | number | number | rate | seeds | ratio | head | Rough | Brown | Milled |
| Class | (cm) | (cm) | (n) | (n) | (%) | (g) | (%) | (g) | rice | rice | rice |
| Wood | 64.9 | 16.5 | 18.3 | 87.0 | 82.5 | 21.5 | 82.7 | 3,223 | 710.1 | 586.8 | 539.8 |
| capsule | | | | | | | | | | | |
| for | | | | | | | | | | | |
| fertilizer | | | | | | | | | | | |
| (pine) | | | | | | | | | | | |
| Chemical | 65.9 | 17.5 | 16.5 | 80.7 | 80.0 | 22.2 | 82.9 | 2,643 | 621.0 | 514.8 | 473.7 |
| fertilizer | | | | | | | | | | | |

TABLE 9
Fertilizing effects of chemical fertilizer and wood chip capsule for fertilizer applied
for Oryza sativa at Gangwon Agricultural Research and Extension Services.

| | | | | | | | A | | | | |
|---|---|---|---|---|---|---|---|---|---|---|---|
| | | | | | | | brown/ | Weight of | | | |
| | | | | | Grain | | rough | rough rice | Yield per 10a | | |
| | Culm | Panicle | Panicle | Grain | filling | Weight | rice | of 100 | (kg/10a) | | |
| | Length | length | number | number | rate | of 1000 | rate | head | Rough | Brown | Milled |
| Class | (cm) | (cm) | (n) | (n) | (%) | seeds (g) | (%) | (g) | rice | rice | rice |
| larch | 82.4 | 20.7 | 17.6 | 84.1 | 82.2 | 24.6 | 82.6 | 3084 | 789.4 | 651.8 | 599.6 |
| Quercus | 80.4 | 19.9 | 14.0 | 89.3 | 82.9 | 24.5 | 81.8 | 2945 | 753.9 | 616.9 | 567.6 |
| pine | 83.4 | 20.4 | 19.2 | 84.9 | 81.8 | 24.7 | 82.4 | 3012 | 771.1 | 635.7 | 584.8 |
| Chemical | 65.9 | 17.5 | 16.5 | 80.7 | 80.0 | 22.2 | 82.9 | 2,643 | 621.0 | 514.8 | 473.7 |
| fertilizer | | | | | | | | | | | |

### Experimental Example 3-2

### Fertilizing Effect of the Present Wood Capsule to Chinese Cabbage Grown in Spring

After wood chip capsules for fertilizer being applied in field, the fertilizing effect of them was studied through investigation into crop situation of Chinese cabbage (Brassica campestris subsp. napus var. pekinensis). The species of the wood chip capsule for fertilizer applied was a pine. The crop situation was evaluated with factors such as total weight, bulb weight, bulb height, bulb width, the number of outer leaf, the number of inner leaf, the widest leaf, the longest leaf, wet weight, dry weight and dry weight rate. The average value denotes average of seven samples. Total weight denotes the weight of whole Chinese cabbage. Bulb weight denotes weight of Chinese cabbage without outer leafs. Bulb height denotes height of Chinese cabbage without outer leafs. Bulb width denotes the width Chinese cabbage without outer leafs. The number of inner leaf denotes the number of inner leaf over 1 cm. The widest leaf denotes the most wide outer leaf. The longest leaf denotes the longest outer leaf and dry weight rate denotes the value of dry weight divided by wet weight.

Table 10 represents crop situation of Chinese cabbage in vinyl house. By research of fertilizing effect to Chinese cabbage, dry weight rate, the most important factor, showed same value by 6.4% in the wood chip capsule for fertilizer and the chemical fertilizer. If dry weight rate from the chemical fertilizer was 100% in contrast, that of the wood chip capsule for fertilizer is also 100%. Thus, the fertilizing effect of the wood chip capsule is as good as the chemical fertilizer.

TABLE 10
Crop situation of Chinese cabbage grown in spring inside
vinyl house according to application of the wood chip
capsules for fertilizer and the chemical fertilizer.

| Class | Chemical fertilizer | Wood chip capsule |
|---|---|---|
| Total weight(g) | 2,024 | 1,977 |
| Bulb weight(g) | 1,154 | 1,005 |
| Bulb height(cm) | 20.0 | 18.0 |
| Bulb width(cm) | 11.0 | 10.0 |
| The number of outer leaf(n) | 13.0 | 15.0 |
| The number of inner leaf(n) | 77.0 | 70.0 |
| The most wide leaf(cm) | 33.0 | 31.0 |
| The longest leaf(cm) | 46.0 | 44.0 |
| Dry weight rate(%) | 6.4 | 6.4 |
| Dry weight rate in contrast | 100 | 100 |

To study effects of the chemical fertilizer and the wood chip capsule for fertilizer further, an investigation of crop situation was performed after having chemical fertilizer and wood chip capsule for fertilizers manufactured of Pinus koraiensis, a larch and Populus tomentiglandulosa been applied for Chinese cabbage in highland. (Table 11) Research factors was total weight, bulb weight, bulb height, bulb width, the number of outer leaf, the number of inner leaf, the most wide leaf, the longest leaf, wet weight, dry weight and dry weight rate. By research of fertilizing effect to Chinese cabbage, dry weight rate, the most important factor, was 4.31% in the chemical fertilizer, 4.96% in Pinus koraiensis, 4.87% in Populus tomentiglandulosa and 4.30% in larch. If dry weight rate in contrast is 100% in the chemical fertilizer, it is 115% in Pinus koraiensis, 112.9% in Populus tomentiglandulosa and 99.7% in larch. Thus, the wood chip capsule made of larch showed almost same value as the chemical fertilizer and the wood chip capsule made of Pinus koraiensis or Populus tomentiglandulosa showed higher values than the chemical fertilizer did.

TABLE 11
Crop situation of Chinese cabbage in highland according to
applications of the chemical fertilizer and the wood chip capsule
for fertilizer manufactured according to the present invention.

| | | | Wood | |
|---|---|---|---|---|
| | | Wood capsule | capsule | Wood |
| | Chemical | (Populus | (Pinus | capsule |
| Class | fertilizer | tomentiglandulosa) | koraiensis) | (larch) |
| Total | 1,891 | 2,337 | 1,993 | 2,469 |
| weight(g) | | | | |
| Bulb | 1,491 | 1,621 | 1,325 | 1,654 |
| weight(g) | | | | |
| Bulb | 21.2 | 20.1 | 18.1 | 22.5 |
| height(cm) | | | | |
| Bulb | 13.6 | 14.1 | 12.8 | 14.0 |
| width(cm) | | | | |
| The number | 9.85 | 10.0 | 11.0 | 11.8 |
| of outer | | | | |
| leaf(n) | | | | |
| The number | 93.9 | 91.8 | 87.0 | 101 |
| of inner | | | | |
| leaf(n) | | | | |
| The most | 28.5 | 29.6 | 29.7 | 32.8 |
| wide | | | | |
| leaf(cm) | | | | |
| The longest | 38.3 | 36.6 | 36.7 | 39.5 |
| leaf(cm) | | | | |
| Dry weight | 4.31 | 4.87 | 4.96 | 4.30 |
| rate(%) | | | | |
| Dry weight | 100 | 112.9 | 115.0 | 99.7 |
| rate in | | | | |
| contrast | | | | |

To synthesis of said results, the wood chip capsule for fertilizer-applied Chinese cabbage showed higher dry weight rate than the chemical fertilizer-applied Chinese cabbage. It was found out that production in the field wherein the wood chip capsule for fertilizer manufactured according to the present invention was applied once a year increased compared to several application of the chemical fertilizer. It is believed that the reason for this is that nitrogen, phosphorous and potassium components should be supplied continuously to crops for entire growth period. Therefore, the wood chip capsule may be highly available as a slow-release fertilizer for cabbage as well as rice, and for other crops.

### Experimental Example 3-3

### A Content Analysis After Application of the Wood Chip Capsules for Fertilizer of the Present Invention

After the wood chip capsule for fertilizer manufactured to the present invention being applied, the content of nitrogen and phosphorous in soil were analyzed and compared with samples collected by depths from the soil where Chinese cabbages were grown. Nitrogen content in soil sample collected under 0˜10 cm deep was high in order of Populus tomentiglandulosa, Pinus koraiensis, chemical fertilizer, Quercus, larch. Also, nitrogen content in soil sample collected under 10˜20 cm deep was high in order of Pinus koraiensis, Populus tomentiglandulosa, chemical fertilizer, Quercus, larch. Nitrogen content was lower in the cases of Quercus and larch than in the case of chemical fertilizer, but in the cases of Populus tomentiglandulosa and Pinus koraiensis showed high nitrogen content. Whereas, phosphorous content was so little compared to nitrogen and was not different apparently between the chemical fertilizer and the wood chip capsule for fertilizers.

TABLE 12
Contents of nitrogen and phosphorous according to depth
in soil after applications of the wood chip capsule for
fertilizer of the present invention and the chemical fertilizer.

| | |
|---|---|
| Total | |
| phosphorous | Total nitrogen |

| samples | ppm | P(%) | ppm | N(%) |
|---|---|---|---|---|
| Pinus koraiensis | 65.8 | 0.0066 | 22,400 | 2.24% |
| 0˜10 cm | | | | |
| Pinus koraiensis | 60.2 | 0.0060 | 39,200 | 3.92% |
| 10˜20 cm | | | | |
| Larch | 54.9 | 0.0055 | 18,200 | 1.82% |
| 0˜10 cm | | | | |
| Larch 10˜20 cm | 53.8 | 0.0054 | 18,200 | 1.82% |
| Quercus 0˜10 cm | 58.2 | 0.0058 | 19,600 | 1.96% |
| Quercus 10˜20 cm | 60.1 | 0.0060 | 19,600 | 1.96% |
| Populus | 51.5 | 0.0052 | 23,800 | 2.38% |
| tomentiglandulosa | | | | |
| 0˜10 cm | | | | |
| Populus | 59.5 | 0.0060 | 32,200 | 3.22% |
| tomentiglandulosa | | | | |
| 10˜20 cm | | | | |
| chemical fertilizer | 75.5 | 0.0076 | 21,000 | 2.10% |
| 0˜10 cm | | | | |
| chemical fertilizer | 68.1 | 0.0068 | 25,200 | 2.52% |
| 10˜20 cm | | | | |

### Experimental Example 3-4

### Relationship Between Composting and Soil

The wood chip capsule for fertilizer in the present invention is a slow-release fertilizer that acts as chemical fertilizer as well as organic fertilizer. Upon finishing it's role as fertilizer, the wood chip capsule of the present invention becomes organic fertilizer as plant cell. Thus, decay of the capsule as plant cell supplies the soils with organic materials to increase humus, and which makes the soils fertile.

Accordingly, a study on composting of wood chip capsules for fertilizer was accomplished to find out whether and how much they act as an organic fertilizer actually. Table 13 represents composting of the wood chip capsules. Composting was given by following formula.
Composting=(total dry weight of non-treated wood−total dry weight of treated wood)/total dry weight of non-treated wood×100%

TABLE 13
Composting of the wood chip capsule for
fertilizer of the present invention.

| | | Date | |
|---|---|---|---|
| Crops | Species | of fertilizing | Composting |
| Chinese cabbage at | Pinus koraiensis | Aug. 25, 1999 | 2% |
| Agricultural | Populus | ″ | 9% |
| Research | tomentiglandulosa | | |
| Rice at Agricultural | Pinus | May 15, 2001 | 14% |
| Research | Larch | ″ | 20% |
| | Quercus | ″ | 23% |
| Chinese cabbage at | Pinus koraiensis | Apr. 8, 2000 | 2% |
| Hongcheon | Larch | ″ | 25% |
| | Quercus | ″ | 45% |
| Chinese cabbage at | Pinus | Mar. 19, 2001. | 2% |
| Joongdo | | | |

Judged by the experiment, composting of the wood chip capsules for fertilizer showed differences according to the species of wood, however, but the wood chip capsules played a role as an organic fertilizer.

### Experimental Example 3-5

### Residues in the Wood Chip Capsule for Fertilizer of the Present Invention

Nitrogen and phosphorous residues in the wood chip capsules for fertilizer were researched. The amounts of nitrogen and phosphorous residues in the wood chip capsules applied for Chinese cabbage at Agricultural Research were both 2.43%. The amounts of nitrogen and phosphorous residues in the wood chip capsules applied for rice at Agricultural Research were average 1.01% and 0.76%. And at Hongcheon they were 0.93% and 0.86%, at Joongdo they were 1.43% and 4.43%.

In the case of Chinese cabbage at Agricultural Research, despite having passed two years after fertilizing, nitrogen and phosphorous still remained in the wood chip capsules for fertilizer. The amounts of nitrogen and phosphorous residues in the wood chip capsules do not correspond to the date of fertilizing. This tendency is thought to be due to the type of the soils. The soils of Hongcheon and Joongdo are both sandy soils. From the result of the experiment, the residues in the wood chip capsule applied at Joongdo the current year were higher than the residues in the wood chip capsule applied at Hongcheon the past year

TABLE 14
Nitrogen and phosphorous residues in the wood chip capsules
for fertilizer of the present invention.

| | | | | Phos- |
|---|---|---|---|---|
| | | Date of | Nitrogen | phorous |
| Crops | Species | fertilizing | residues | residues |
| Chinese | Pinus | Aug. 25, 1999 | 2.94% | 2.64% |
| cabbage at | koraiensis | | | |
| Agricultural | Populus | ″ | 1.92% | 2.22% |
| Research | tomentiglandulosa | | | |
| Rice at | Pinus | May 15, 2001 | 0.23% | 0.60% |
| Agricultural | Larch | ″ | 2.55% | 0.65% |
| Research | Quercus | ″ | 0.25% | 1.03% |
| Chinese | Pinus | Apr. 8, 2000 | 1.68% | 1.13% |
| cabbage at | koraiensis | | | |
| Hongcheon | Larch | ″ | 0.80% | 0.89% |
| | Quercus | ″ | 0.30% | 0.55% |
| Chinese | Pinus | Mar. 19, 2001 | 1.43% | 4.43% |
| cabbage | | | | |
| at Joongdo | | | | |

### INDUSTRIAL APPLICABILITY

As like illustration mentioned above, a wood chip capsule for fertilizer in the present invention can supply slow-release organic fertilizer and increase the porosity of soil making the supply of air easier. And it is decomposed by microbial organisms to supply the soils with organic nutrients during the crop cultivation period. Due to original repellant component, furthermore, efficacy of wood chip capsules for Disease and Insect Control enables grower to reduce the use of pesticides and fertilizer. In conclusion, an overuse of quick-acting chemical fertilizer has caused damage to crops and excess base accumulation in soil. A wood chip capsule for fertilizer manufactured according to the present invention is a much useful invention in agricultural industry, because the present invention as a slow-release fertilizer causes no damage to crops, increases production and saves labor due to no need of additional application during growth period.

What is claimed is:

1. A method for manufacturing a wood chip capsule, which comprises the steps of:
(a) manufacturing a wood chip;
(b) drying naturally to 10˜40% water content; and
(c) permeating more than one selected from the group consisting of fertilizer, pesticides and plant growth regulator into the wood chip prepared in the step (a) by pressurized method or immersion method.

2. The method for manufacturing the wood chip capsule of claim 1 in which the pressurized method is maintained at 1˜40 kgf/cm².

3. The method for manufacturing the wood chip capsule of claim 1 in which the pressurized method is maintained at the range 720 mmHg-760 mmHg vacuums for fertilizers, pesticides and plant growth regulator to be permeated sufficiently into the wood chip.

4. A method for controlling a dissolving-out velocity of fertilizer, agriculture pesticide or plant growth regulator from the wood chip capsule by changing size of the wood chip mentioned in claim 1.

5. A method for controlling a dissolving-out velocity of fertilizer, agriculture pesticide or plant growth regulator from the wood chip capsule by changing kind of the wood chip mentioned in claim 1.

6. A method for controlling a dissolving-out velocity of fertilizer, agriculture pesticide or plant growth regulator from the wood chip capsule by coating the wood chip mentioned in claim 1 using coating substances.

7. The method for controlling a dissolving-out velocity of fertilizer, agriculture pesticide or plant growth regulator from the wood chip capsule in claim 6 by using mixture of more than one selected from a group which comprises calcium, magnesium, iron, manganese, copper, zinc, silicon, magnesia, clay and lime or one selected from a group which comprises peanut hulls, yeast-containing waste material and fish waste material as said coating substance.

8. A wood chip capsule manufactured by a method, which comprises the steps of:
(a) manufacturing a wood chip;
(b) drying naturally to 10˜40% water content; and
(c) permeating more than one selected from the group consisting of fertilizer, pesticides and plant growth regulator into said wood chip by pressurized method or immersion method.

9. A using method for the wood chip capsule, which comprises the steps of:
(a) manufacturing a wood chip;
(b) drying naturally to 10˜40% water content;
(c) permeating more than one selected from the group consisting of fertilizer, pesticides and plant growth regulator into said wood chip by pressurized method or immersion method; and
(d) mixing at different rates according to the uses and applying the wood chip capsule produced said step (c)

10. An apparatus for manufacturing a wood chip capsule consisting of:
an electric controller 10, which senses and controls on/off operation of a power switch 8 supplying an electric current;
a vacuum pump 12 operated by previously fixed information of said electric controller 10;
a mixing tank 6, which becomes vacuum inside due to connection to a vacuum pipe 16 which has an aperture valve of vacuum operated by a signal of said electric controller 10, is equipped with an aperture for chip 4 and a pressure gage 20 on the upper, has an exit valve 36 in exit pipe 34 connected to the lower and is electrically connected to pressure gage, an indicating instrument and a recorder;
a tank of solution 26 which is connected and set to a pipe of solution 22 equipped with a check valve 28 and an aperture valve of solution 24 operated by signal of the electric controller 10 to supply with definite amount of solution to said mixing tank 6; and
a high pressure pump 14 which is connected and set with a high pressure pipe 30 equipped with a high pressure valve 32 diverged from said a pipe of solution 22 and operated by signal of the electric controller 10.
